(19) United States
(12) Patent Application Publication
(10) Pub. No.: US 2024/0220982 A1
(43) Pub. Date: Jul. 4, 2024

(54) TRANSACTION CLASSIFICATION AT A POINT OF SALE

(71) Applicant: MASTERCARD INTERNATIONAL INCORPORATED, PURCHASE, NY (US)

(72) Inventor: Corey ELLIS, St. Peters, MO (US)

(21) Appl. No.: 18/150,190

(22) Filed: Jan. 4, 2023

(51) Int. Cl. G06Q 20/40

(52) U.S. Cl. CPC G06Q 20/401

(57) ABSTRACT

The disclosure herein describes collecting transaction class codes of transactions at a POS interface and organizing those transactions based on the class codes. A class code manager receives a notification that a transaction associated with an account has been initiated. The class code manager sends a prompt to collect a transaction class code of the transaction. In some examples, the transaction class code is a code from a plurality of transaction class codes associated with the account. A transaction class code is received in response to the prompt and the received transaction class code is associated with the transaction. A transaction record of the transaction is recorded by the class code manager, including the associated transaction class code and transaction data of the transaction. The recorded class codes of transactions are used to organize and analyze transaction data. Further, suggested class codes are generated using machine learning in some examples.

### BACKGROUND

Payment accounts are often used for a wide variety of purposes and types of transactions. Keeping records of such transactions organized can be challenging because transactions associated with different merchants and/or different payment processors may not use similar names, categories, or descriptions.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A computerized method for collecting transaction class codes of transactions at a point-of-sale (POS) interface and for organizing those transactions based on the class codes is described. A class code manager receives a notification that a transaction associated with an account has been initiated. The class code manager sends a prompt to collect a transaction class code of the transaction. In some examples, the transaction class code is a code from a plurality of transaction class codes associated with the account. A transaction class code is received in response to the prompt and the received transaction class code is associated with the transaction, or the transaction is “tagged” with the transaction class code. A transaction record of the transaction is recorded by the class code manager, including the associated transaction class code and transaction data of the transaction. Later, the recorded class codes of transactions are used to organize, interpret, and/or analyze transaction data.

### BRIEF DESCRIPTION OF THE DRAWINGS

The present description will be better understood from the following detailed description read in light of the accompanying drawings, wherein:

FIG. 1 is a block diagram illustrating a system configured to collect transaction class codes for transactions via a point-of-sale (POS) interface;

FIG. 2 is a diagram illustrating a graphical user interface (GUI) of a POS interface associated with a merchant;

FIG. 3A is a diagram illustrating a GUI displaying a transaction statement with transactions sorted by class code;

FIG. 3B is a diagram illustrating a GUI displaying a transaction statement with transactions sorted by date;

FIG. 4 is a diagram illustrating a process of collecting a class code of a transaction by a class code manager in a system;

FIG. 5 is a diagram illustrating a process of training a classification model and providing suggested class codes of a transaction using the trained classification model;

FIG. 6 is a flowchart illustrating a method of collecting a class code of a transaction; and

FIG. 7 illustrates an example computing apparatus as a functional block diagram.

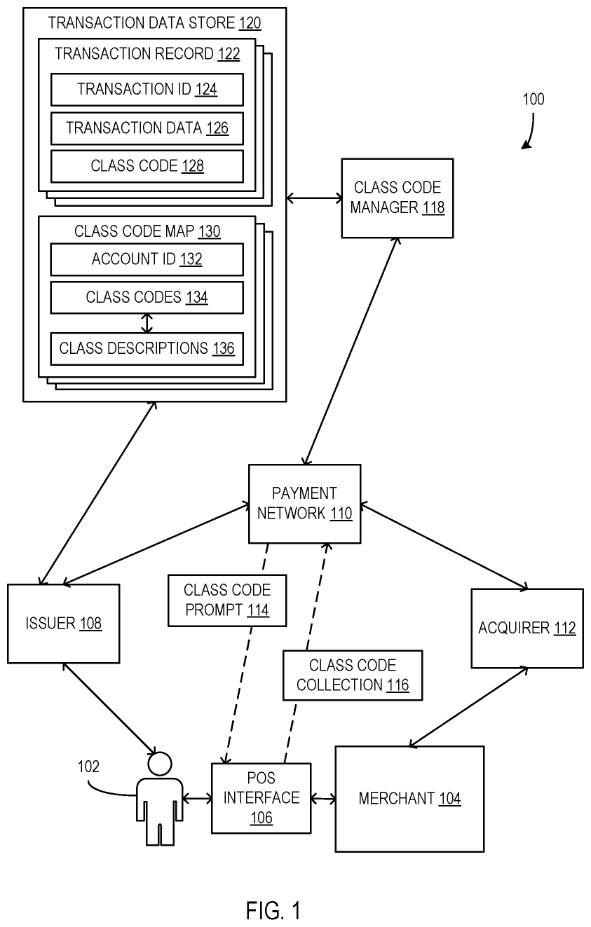

Corresponding reference characters indicate corresponding parts throughout the drawings. In FIGS. 1 to 7, the systems are illustrated as schematic drawings. The drawings may not be to scale. Any of the drawings may be combined into a single example or embodiment.

### DETAILED DESCRIPTION

Aspects of the disclosure provide a computerized method and system for collecting transaction class codes of transactions, for example at a point-of-sale (POS) interface, and for analyzing and organizing those transactions based on the class codes. A class code manager receives a notification that a transaction associated with an account has been initiated. The class code manager sends a prompt to collect a transaction class code of the transaction. In some examples, the transaction class code is a code selected from a plurality of transaction class codes associated with the account. A transaction class code is received in response to the prompt and the received transaction class code is associated with the transaction, or the transaction is otherwise “tagged” with the transaction class code. A transaction record of the transaction is recorded by the class code manager, including the associated transaction class code and transaction data of the transaction. Subsequently, the recorded class codes of transactions are used to organize, interpret, and/or analyze transaction data.

The disclosure operates in an unconventional manner at least by using the transaction initiation process on a POS interface to prompt a user to provide the transaction class code. By leveraging the interaction between the user and the POS interface that is required to complete the transaction to collect the class code, resource usage, bandwidth usage, and other computation costs associated with categorizing or classifying the transaction through other means is avoided. For example, the other means include prompting a user for a class code after the transaction, using other devices, etc. Further, the use of the POS interface to collect the class code at the time of the transaction enhances the accuracy with which class codes are assigned to transactions, as a user assigning a class code to a transaction during initiation of that transaction is more likely to have detailed, recent knowledge of the transaction and what class code fits the transaction best. This improves the accuracy of the transaction tagging.

Further, the disclosure describes the automatic generation (e.g., generated by a computing device at the time of the transaction) of suggested class codes for transactions based on historical transaction data. In some examples, those suggested class codes are generated using machine learning techniques, such as a trained classification model. The generation and provision of suggested class codes to a user when prompting the user to provide a class code for a transaction streamlines the process and improves the accuracy and speed of the class code selection process. By generating a suggested class code that is likely to be the correct code for association with the transaction, the disclosure reduces the likelihood of an inaccurate code being manually selected or provided, reduces the time required to complete the class code selection process, and reduces the amount of computation resources needed.

Additionally, the disclosure describes the use of hierarchical structures of transaction class codes and class descriptions that are mapped to defined class codes. Both features enhance the flexibility and usability of the class codes with respect to organizing, analyzing, and/or displaying transactions and associated class codes. Organizations that use complex structures of transaction class codes are enabled to define class codes and sub-class codes with increasing specificity and granularity, such that budgeting and other types of analytical processes are improved. The use of mapped descriptions to class codes ensures that each class code has a unique code value and a human-readable description, improving the usefulness of transaction statements, reports, or other means of displaying and/or reviewing sets of transactions and associated class codes.

FIG. 1 is a block diagram illustrating a system 100 configured to collect transaction class codes 128 for transactions via a POS interface 106. In some examples, a user 102 initiates a transaction with a merchant 104 at least in part using a POS interface 106. The transaction is facilitated by an issuer 108, a payment network 110, and an acquirer 112 as described herein. During the transaction, the user 102 is prompted to provide a class code 128 to associated with the transaction based on a class code prompt 114 from the payment network 110 and the provided class code 128 is collected from the POS interface 106 during class code collection 116 by the payment network 110. The payment network 110 stores transaction data of the transaction as a transaction record 122 in a transaction data store 120 through interactions with a class code manager 118 as described herein. It should be understood that, while the illustrated system 100 includes the payment network 110 interacting with the class code manager 118 to collect and store provided class codes 128, in other examples, the class code manager 118 is used by the issuer 108, the acquirer 112, or another entity of the system 100 to collect and store such class codes 128. In still other examples, the class code manager 118 is configured to operate independently of other entities in the system 100 to collect, store, and/or otherwise manage class codes 128 and/or other transaction data as described herein without departing from the description.

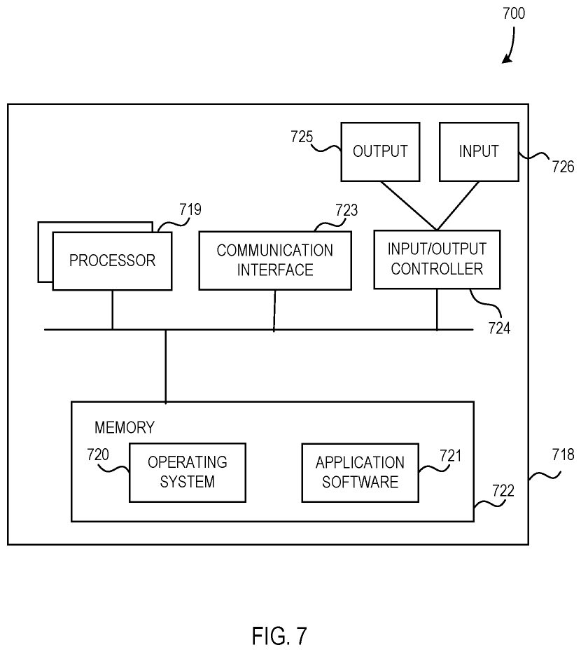

In some examples, the system 100 includes a computing device, such as the computing device of FIG. 7 Further, in some examples, the system 100 includes multiple computing devices that are configured to communicate with each other via one or more communication networks (e.g., an intranet, the Internet, a cellular network, other wireless network, other wired network, or the like). In some such examples, entities of the system 100 are configured to be distributed between the multiple computing devices and to communicate with each other via network connections. In an example, the issuer 108, the payment network 110, the acquirer 112, and the merchant 104 are located on and/or associated with different computing devices that are configured to communicate with each other by a communication network. The class code manager 118 is configured to be executed on one or more computing devices associated with the payment network 110. The issuer 108, payment network 110, acquirer 112, and merchant 104 all work together using network communications over the communication network to facilitate the transaction as described herein. In other examples, other arrangements or organizations of multiple computing devices are used in the system 100 without departing from the description.

In some examples, the user 102 has a card or other device associated with a credit account, debit or bank account, or other similar financial account of the user 102. The associated account is issued to the user 102 by the issuer 108 (e.g., a bank, credit union, or other account issuing entity that has issued the user 102's account to the user 102, etc.). In examples where the user 102 has a computing device that is associated with the account, the computing device includes an application (e.g., a mobile app, etc.) associated with the user's account and/or provided by the issuer 108, the payment network 110, and/or another bank or similar entity.

In some examples, at the merchant 104, the user 102 initiates a transaction such that the payment for the transaction is directed from the associated account of the user 102. The user 102 interacts with the point of sale (POS) interface 106 at the merchant 104 using components of the interface as described herein. In an example, the user 102 touches portions of a touchscreen of the POS interface 106 to select choices and/or otherwise provide information associated with the transaction, such as a class code 128 as described herein. Alternatively, or additionally, the user 102 uses a computing device that includes a POS interface 106 application to communicate with the merchant 104 over the Internet or other similar network communication.

The merchant 104 has an account or accounts in which it receives payment for transactions. The merchant 104's account is issued to the merchant 104 or a party associated with the merchant 104 by the acquirer 112 (e.g., a bank, credit union, other issuing and/or acquiring entity that has issued the merchant 104's account to the merchant 104 and acquires payment from the user 102's account, etc.). During a transaction initiated by the user 102 at the merchant 104, the transfer of funds between the user 102's account and the merchant 104's account includes interaction between the issuer 108 and acquirer 112, which is facilitated by the payment network 110. In some examples, the transaction facilitation via the issuer 108, payment network 110, and acquirer 112 occurs according to any methods of processing credit card transactions or other similar transactions without departing from the description (e.g., authentication, authorization, clearing, settlement, or the like).

In some examples, the class code manager 118 includes hardware, firmware, and/or software configured to collect class codes 128 from the user 102 during a transaction and to store the collected class codes 128 in association with other transaction data 126 of the transaction in a transaction record 122. As illustrated, the class code manager 118 is part of or otherwise associated with the payment network 110, but in other examples, the class code manager 118 is associated with other entities in the system 100 or it is independent of other entities in the system 100 without departing from the description.

Further, the class code manager 118 is configured to send a class code prompt 114 or otherwise cause an entity such as the payment network 110 to send a class code prompt 114 to the user 102 during the transaction, such that the user 102 is prompted to provide a class code 128 by the POS interface 106 or other similar interface (e.g., an app on a mobile device that provides POS functionality). The class code manager 118 is further configured to cause the provided class code 128 to be collected during a class code collection 116 and provided to the class code manager 118 directly or via another entity, such as the payment network 110. In some such examples, the class code prompt 114 and/or class code collection 116 processes are combined with other interactions that the payment network 110 is already configured to perform during transaction facilitation, such that changes to the typical transaction processing operations of the payment network 110 are reduced or limited. In an example, the payment network 110 includes class code prompt 114 instructions to the POS interface 106 with other instructions to prompt the user 102 for information (e.g., prompting the user 102 to provide a PIN or other authenticating information) and the class code collection 116 is configured to occur when the POS interface 106 and the associated merchant 104 send transaction data 126 of the transaction to the payment network 110 during the course of the transaction being processed.

In some examples, the transaction data store 120 is configured to store transaction records 122, each of which includes a transaction ID 124, some set of transaction data 126, and/or a class code 128. Further, the transaction data store 120 is configured to make the transaction records 122 available to other entities in the system, such as the class code manager 118 and/or the issuer 108. Additionally, in other examples, the transaction records 122 in the transaction data store 120 are made accessible to the user 102 via an interface of the issuer 108 or payment network 110 or independently of the other entities of the system 100. The transaction ID 124 of a transaction record 122 uniquely or pseudo-uniquely identifies a transaction among a set of transactions in the transaction data store 120 and the transaction data 126 includes some or all data associated with the transaction, such as date/time data, merchant data, user data, location data, data about items or services purchased, cost data, data about accounts used to complete the transaction, or the like. In addition to the transaction data 126, the record 122 includes the collected class code 128, which represents a classification of the transaction assigned by the user 102 when the transaction was initiated/processed.

In some examples, the class codes 128 are defined by the user 102, such that the user 102 controls how they are used to classify different transactions. In an example, the user 102 has defined a set of class codes 128 that represent different budget categories for the user's personal budget. When the user 102 makes a purchase, they select a class code 128 for the transaction that matches the budget category of the purchase (e.g., groceries, household goods, clothing, hobbies, or the like). In other examples, the class codes 128 are defined to represent transactions associated with different departments of a company, transactions associated with different clients of a company, or the like.

In some such examples, the user 102 is enabled to define such class codes 128 by the class code manager 118, account issuer 108, and/or the payment network 110 associated therewith. For example, the user 102 is enabled to log into a website or application interface to view their account and to view and/or change their defined class codes 128 (e.g., in a class code map 130). The class codes 128 the user defines are associated with their account specifically via an account ID 132, though in some examples, the interface provides common class codes 128 used by many people or otherwise includes a default set of class codes 128 that the user can use, change, or delete.

Further, in some examples, the class codes 128 are formatted as numerical values (e.g., 3, 4 or 5-digit numbers), alpha-numeric values, or other data formats without departing from the description. Additionally, or alternatively, defining the class codes 128 includes defining the code value portions of the class codes 134 and defining associated class descriptions 136 associated with each class code 134 in a class code map 130. Then, those defined class codes 134 and associated class descriptions 136 are used as class codes 128 in transaction records 122. In an example, the user 102 defines a class code 134 value of 10001 and an associated class description 136 of “groceries”. In some such examples, the user 102 is enabled to enter a code value 10001 of a class code 128 at the POS interface 106 and then have the associated class description 136 of that class code 128 used in reports and/or statements including that transaction, such that transactions that are sorted according to class codes 128 are sorted into a “groceries” class. The defined class codes 134 and any mapped class descriptions 136 is stored in association with the user's account using an account ID 132 in the transaction data store 120 as illustrated and/or in another data store of the system 100 without departing from the description.

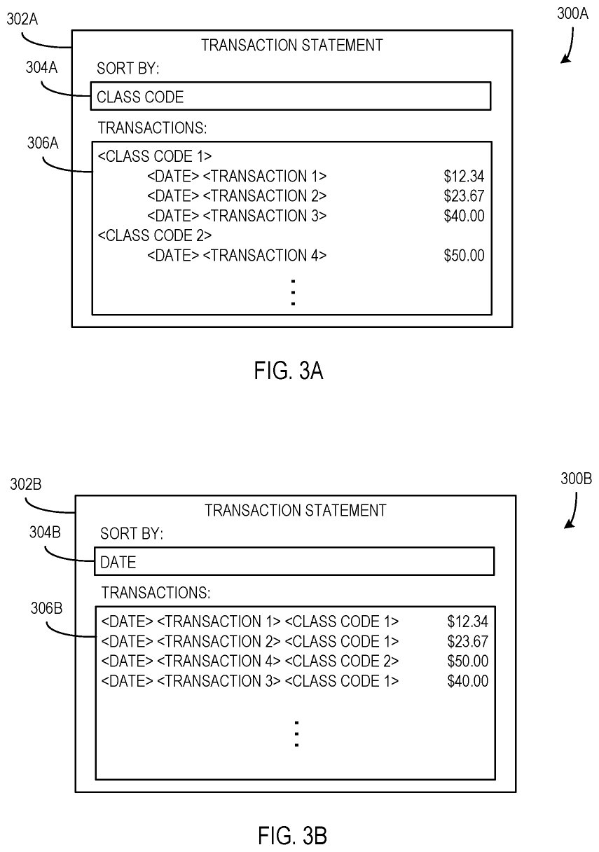

In some examples, the class codes 128 associated with the transactions of the transaction records 122 are used to display contextual classification information in association with transaction data and/or to sort or organize transactions. In some examples, the class code manager 118, issuer 108, and/or payment network 110 are configured to generate transaction reports or statements that are provided to the user 102. The generated transaction statements display transaction data 126 and class codes 128 of transaction records 122. Exemplary transaction statements are described in greater detail below with respect to FIGS. 3A-B. In some such examples, a listing for each displayed transaction is included with a set of transaction data 126 in each listing. The listings further include the class codes 128 and/or associated class descriptions 136 thereof (e.g., a listing of a grocery transaction that includes the class code 128 that represents “groceries” and/or a descriptive string value of a class description 136 that indicates the transaction is associated with the “groceries” classification).

Further, in some examples, the class codes 128 and/or 134 are defined in a hierarchical structure. In an example, a first class code 128 is defined to represent transactions associated with a client of a company generally. Additionally, a subset of other class codes 128 is defined to represent transactions associated with types of transactions that are associated with that client, such that the subset of other class codes 128 are sub-codes of the first class code 128 associated with the client generally. Thus, a user 102 is enabled to assign the generally class code 128 to a transaction or to assign a more specific class code 128 associated with the type of transaction to the transaction (e.g., a class code 128 associated with travel costs on behalf of the client, fees paid on behalf of the client, or the like). In some such examples, the class code values used in such hierarchical structures are defined in a logical manner. For example, the general client code value described above is 10000 and the values of the sub-codes of that client are included in the value range of 10001-10099. In some such examples, a second client code value is 10100 and sub-codes of the second client are included in the value range of 10101-10199.

In some examples, the class code prompt 114 includes providing the user 102 with class codes 134 and/or associated class descriptions 136 to choose from. In an example, the user 102 has defined three different class codes 134 in a class code map 130 associated with the user's account ID 132 and those three defined class codes 134 are displayed to the user on the POS interface 106, enabling the user 102 to choose from those three codes 134 to be used as a class code 128 of the transaction.

Further, in some examples, the class codes 134 provided to the user 102 via the class code prompt 114 are selected by the class code manager 118 or other entity of the system 100 (e.g., as suggested class codes 134). In examples where the quantity of defined class codes 134 makes it impractical to offer the user 102 the choice of all defined class codes 134, the class code manager 118 is configured to select the suggested class codes 134 to be displayed to the user 102. In some such examples, the suggested class codes 134 determined by the class code manager 118 include a subset of the most frequently assigned class codes 134 in association with the account ID 132 of the current transaction. For example, the class code manager 118 is configured to track the use of each class code 134 as a class code 128 in transaction records 122 such that the most used three class codes 134 are provided to the user 102 as suggested class codes 134 to assign to the transaction.

Alternatively, or additionally, the class code manager 118 is configured to determine suggested class codes 134 based on transaction data 126 of the current transaction and on transaction history data of past transactions. In an example, the class code manager 118 determines a class codes 128 used for transaction records 122 of past transactions at the same merchant 104 and provides that determined class code 128 as a suggested class code 134 for the user 102 to choose via the POS interface 106. In other examples, other types of transaction data 126 (e.g., location data, date/time data, transaction type data) of past transaction records 122 are used to determine class codes 128 of those records 122 to provide them as suggested class codes 134 for selection by the user 102.

Further, in some examples, the class code manager 118 is configured to determine the suggested class codes 134 from patterns of multiple types of transaction data 126 in the transaction records 122 of historical transactions of the users account and/or transactions of other accounts. Additionally, in some such examples, the class code manager 118 is configured to use machine learning techniques to identify such patterns in transaction data 126 of transaction records 122 and to determine the suggested class codes 134 using those identified patterns. In an example, the class code manager 118 includes a classifier model that is trained to classify the current transaction with one or more class codes 128 based on transaction data 126 patterns of current transaction records 122 using machine learning. In such examples, the classifier model is trained using the transaction records 122 with assigned class codes 128 as training data. In other examples, other types of models and/or machine learning training techniques are used without departing from the description.

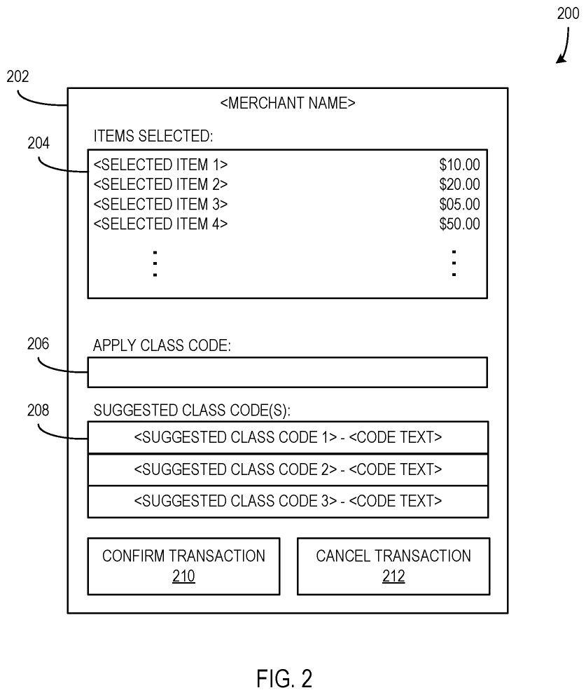

FIG. 2 is a diagram illustrating a Graphical User Interface (GUI) 200 of a POS interface (e.g., POS interface 106) associated with merchant (e.g., merchant 104). In some examples, the GUI 200 is displayed on a POS interface 106 in a system such as system 100 as described herein. The GUI 200 includes a transaction window 202 that includes a selected item section 204, a class code entry section 206, a suggested class code section 208, a confirm transaction button 210, and a cancel transaction button 212.

In some examples, the selected item section 204 displays a list of items selected for purchase by a user in the displayed transaction. In some such examples, the section 204 is updated as the selected items are entered, whether by scanning of a code on the item, manually entered by an employee or representative of the merchant, or by another means. The selected item section 204 displays a name and/or description of the item and the price of the item as illustrated. It should be understood that, in other examples, the selected item section 204 includes more, fewer, or different selected items and/or associated item information without departing from the description.

Further, in some examples, the class code entry section 206 and/or the suggested class code section 208 are displayed on the GUI 200 as a class code prompt (e.g., class code prompt 114) to collect a class code for association with the current transaction as described herein. The class code entry section 206 is configured to display an entered class code and/or enable a user to enter a class code using a keyboard, touchscreen, or other similar user input interface. In an example, the user is prompted to enter a class code, the class code entry section 206 is highlighted, and the user is enabled to enter a class code using a keyboard displayed on a touchscreen interface.

Additionally, or alternatively, the suggested class code section 208 is displayed on the GUI 200 as part of the class code prompt. The suggested class code section 208 is configured to display a set of suggested class codes (e.g., class codes 134) and/or associated class code information (e.g., class descriptions 136). The suggested class codes are determined by another entity of the system, such as a class code manager 118, as described herein. Further, in some examples, the suggested class code section 208 is configured to enable a user to select one of the displayed suggested class codes and to update the class code entry section 206 to include and display the selected suggested class code.

Further, in some examples, the suggested class code section 208 is configured to be updated over time based on the user entering partial class codes in the class code entry section 206. For example, if the user has entered the first two digits of a class code in the class code entry section 206, the suggested class code section 208 is updated to display one or more complete class codes that include the same first two digits as the user has entered in the class code entry section 206. In this way, the user is enabled to manually enter a first portion of a class code and then select a full class code from the suggested class code section 208 to complete the code entered in the class code entry section 206.

The confirm transaction button 210 is configured to enable a user to confirm and/or approve the current transaction, including confirming that the current class code in the class cod entry section 206 is an accurate class code for the transaction. In some examples, when a user presses or otherwise activates the confirm transaction button 210, the associated system proceeds with further processing of the transaction, including collecting the provided class code (e.g., via class code collection 116).

The cancel transaction button 212 is configured to enable a user to cancel the current transaction such that the processing of the current transaction is halted. In some examples, when a user presses or otherwise activates the cancel transaction button 212, the processing of the transaction halts and does not proceed. Additionally, or alternatively, activating the cancel transaction button 212 causes a confirmation interface to be displayed to the user to enable the user to confirm that they want to cancel the transaction. In other examples, other types of buttons or interface components are included in the GUI 200 without departing from the description.

FIGS. 3A-B are diagrams illustrating exemplary GUIs for displaying transaction statements in which the transactions are sorted based on different types of information. FIG. 3A is a diagram illustrating a GUI 300A displaying a transaction statement with transactions sorted by class code. In some examples, the GUI 300A is displayed on an interface component in a system such as system 100. The GUI 300A includes a transaction statement window 302A, a transaction sort section 304A, and a transaction display section 306A.

In some examples, the transaction sort section 304A is configured to display a current method by which the transactions displayed in the transaction display section 306A are sorted. Further, in some such examples, when the GUI 300A is first displayed, the transaction sort section 304A is set to a default method of sorting and the user is enabled to change the method of sorting through interaction with the transaction sort section 304A (e.g., by entering the name of a field for sorting, by selecting a sorting field from a drop-down menu of the section 304A, or the like). As illustrated, the transaction sort section 304A is set to class code, such that the transactions displayed in the transaction display section 306A are sorted by class codes.

The transaction display section 306A is configured to display the transactions of the transaction statement in a sorted order based on the selected sorting field in the transaction sort section 304A. As illustrated, the transactions are sorted according to class code, such that the transactions associated with class code 1 are displayed with a date and transaction amount under a class code 1 heading, the transactions associated with class code 2 are displayed with a date and transaction amount under a class code 2 heading, and so on.

FIG. 3B is a diagram illustrating a GUI 300B displaying a transaction statement with transactions sorted by date. In some examples, the GUI 300B is displayed on an interface component in a system such as system 100. The GUI 300B includes a transaction statement window 302B, a transaction sort section 304B, and a transaction display section 306B.

In some examples, the transaction sort section 304B is configured to display a current method by which the transactions displayed in the transaction display section 306B are sorted. In some such examples, the transaction sort section 304B and transaction display section 306B operate in the same way as the corresponding sections 304A and 306A of GUI 300A described above. As illustrated, the transactions in the transaction display section 306B are sorted by date based on date being selected in the transaction sort section 304B. Each of the transactions is displayed with a date, an associated class code (e.g., class code 1 or class code 2) and a transaction amount. It should be understood that the transactions in the section 306A are not sorted by class code, such that the transaction with a class code of class code 2 is displayed between two other transactions with class codes of class code 1.

In some examples, a user is enabled to switch between the displayed GUIs 300A and 300B by changing the sorting field of the GUI using the associated transaction sort section 304A or 304B.

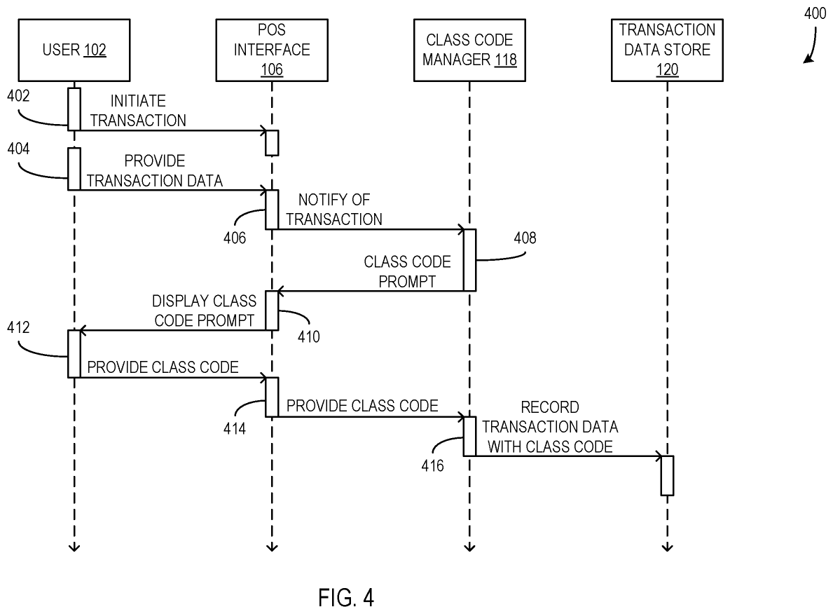

FIG. 4 is a diagram illustrating a process 400 of collecting a class code of a transaction by a class code manager 118 in a system (e.g., system 100). In some examples, the process 400 is executed or otherwise performed in a system such as system 100 of FIG. 1.

At 402, a user 102 initiates a transaction with a POS interface 106. In some examples, initiating the transaction includes the user 102 going to a checkout counter of a merchant and interacting with an employee and/or the POS interface 106. Additionally, or alternatively, the initiating the transaction includes the user 102 interacting with a self-checkout station that includes the POS interface 106.

At 404, the user 102 provides transaction data using the POS interface 106. In some examples, providing the transaction data includes the user 102 scanning or otherwise entering information about the items or services being purchased in the transaction into the POS interface 106 and/or an associated interface. Additionally, or alternatively, an employee of the merchant interacts with the user 102 and they cooperate to provide information about the items or services being purchased. Other transaction data, such as date/time data, location data, or the like, is automatically captured by the POS interface 106 and/or an associated computing device upon the user 102 initiating the transaction and beginning to provide transaction data. Still further, transaction data associated with the user 102's account is provided by the scanning of a card associated with the account (e.g., scanning a credit card) or otherwise collecting account data from the user 102.

At 406, the POS interface 106 notifies the class code manager 118 of the transaction. In some examples, the POS interface 106 interacts with or is monitored by another entity of the system that is in communication with the class code manager 118 (e.g., the POS interface 106 is connected to a computing device that is in communication with the payment network with which the class code manager 118 is associated). Further, in some examples, the POS interface 106 directly or indirectly provides some or all the transaction data to the class code manager 118 for use by the class code manager 118 in recording transaction data later.

At 408, the class code manager 118 sends a class code prompt to the POS interface 106 and, at 410, the POS interface 106 displays the class code prompt to the user 102. In some examples, the class code prompt includes language requesting that the user 102 provide a class code for the transaction and/or an interface component that enables the user 102 to provide the class code (e.g., the class code entry section 206 of FIG. 2).

At 412, the user 102 provides the class code to the POS interface 106 and, at 414, the POS interface 106 provides the class code to the class code manager 118. At 416, the class code manager 118 records a transaction record (e.g., transaction record 122) of the transaction in a transaction data store 120, including the transaction data provided by the user 102 and the class code provided by the user 102. In some examples, transaction records stored in the transaction data store 120 are used to analyze the user 102's behavior and/or to provide organized information to the user 102 or other parties about the transactions represented by the stored transaction records as described herein.

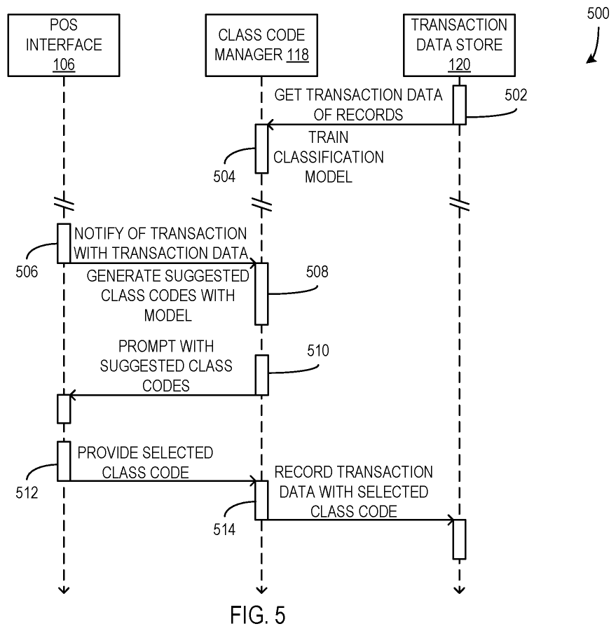

FIG. 5 is a diagram illustrating a process 500 of training a classification model and providing suggested class codes of a transaction using the trained classification model. In some examples, the process 500 is executed or otherwise performed in a system such as system 100 of FIG. 1.

At 502, the class code manager 118 gets transaction data of transaction records from the transaction data store 120 and, at 504, the class code manager 118 trains a classification model using the transaction data of the records. In some examples, the training of the classification model is using machine learning techniques. In an example, the class code manager 118 provides transaction data of the records to the classification model without the included class codes and the classification model generates suggested class codes for each of the transactions for which transaction data was provided. The generated suggested class codes are compared to the actual class codes associated with the transaction records and adjustments to weights and/or other elements of the classification model are made based on differences between the suggested class codes and the actual class codes. In this way, the accuracy of the classification model in generating suggested class codes is increased with respect to the actual class codes of the historical set of transaction records.

It should be understood that, while the training of the classification model is illustrated as being at the beginning of the process 500, in other examples, the training of the classification model occurs before 506 and/or after 514 of the process 500. Further, it should be understood that, in some such examples, the classification model is periodically retrained to make use of the most recent transaction records and to continuously improve the performance of the classification model in generating suggested class codes.

At 506, the POS interface 106 notifies the class code manager 118 of a transaction with transaction data. In some examples, this notification is performed in substantially the same way as the notification at 406 of process 400 as described above.

At 508, the class code manager 118 generates one or more suggested class codes using the classification model and the transaction data received from the POS interface 106 and, at 510, the class code manager 118 provides a class code prompt to the POS interface 106 with suggested class codes. In some examples, the received transaction data is provided to the classification model as input and the classification model generates one or more suggested class codes. In some such examples, the classification model generates a set of multiple suggested class codes with probability values or other ranking values indicating which suggested class codes are more likely to be correct than other suggested class codes. Further, in some such examples, the class code manager 118 controls or filters the generated suggested class codes to ensure that the set of class codes provided to the POS interface 106 are associated with a minimum threshold of probable accuracy (e.g., only suggested class codes that have a probability value of 60% or higher from the classification model are provided to the POS interface 106). Alternatively, or additionally, the class code manager 118 filters out all but the most accurate subset of suggested class codes, such as the top three suggested class codes generated by the classification model based on relative probability or ranking values.

At 512, the POS interface 106 provides a selected class code as selected by a user associated with the transaction and, at 514, the class code manager 118 records transaction data of the transaction with the selected class code as a transaction record in the transaction data store 120. In some examples, 512-514 of the process 500 are performed in substantially the same way as 414-416 of process 400 as described above. Additionally, as mentioned above, in some such examples, the steps of training the classification model of the class code manager 118 at 502-504 are performed again to incorporate the newly recorded transaction record as training data.

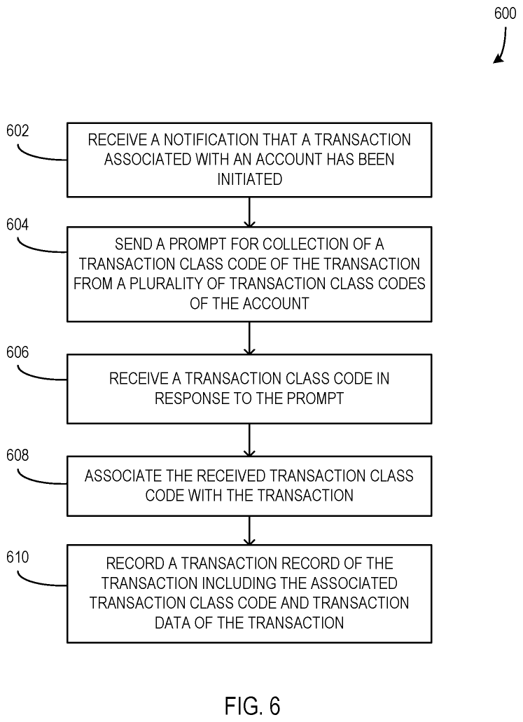

FIG. 6 is a flowchart illustrating a method 600 of collecting a class code (e.g., class code 128) of a transaction. In some examples, the method 600 is executed or otherwise performed by one or more components of a system such as system 100 of FIG. 1.

At 602, a notification is received that a transaction associated with an account has been initiated. In some examples, the notification is sent by a POS interface 106 and/or an associated merchant 104 to a payment network 110 and/or an associated class code manager 118 as described herein. Further, in some such examples, the notification of the initiation of the transaction is part of typical transaction process communications between a merchant, acquirer, payment network, and/or issuer. Additionally, or alternatively, the notification includes transaction data of the transaction, such as date/time data, merchant data, transaction type data, data associated with items being purchased, or the like.

At 604, a prompt is sent for collection of a transaction class code of the transaction from a plurality of transaction class codes of the account. In some examples, the prompt includes a request for a user to provide a transaction class code and/or one or more suggested transaction class codes that the user can choose for the transaction. Further, in some examples where suggested transaction class codes are included, the included suggested transaction class codes are generated based on the transaction data of the transaction and/or transaction data of other historical transactions.

In some examples, a suggested class code for the transaction is generated using a classification model by providing the transaction data of the transaction as input to the model. The model generates the suggested class code as output. Further, in some such examples, the classification model is trained using machine learning techniques. In such examples, transaction data and transaction class codes of transaction records of a plurality of other transaction records are obtained as training data and the obtained transaction data is provided to the classification model as input. The classification model generates a set of suggested transaction class codes as output and those generated transaction class codes are compared to the obtained class codes. The classification model is adjusted (e.g., using machine learning) based on the comparison of the generated class codes to the obtained class codes, such that the accuracy of the classification model is improved with respect to the transaction records used as training data.

At 606, a transaction class code is received in response to the prompt and, at 608, the received transaction class code is associated with the transaction. In some examples, the transaction class code is received by a class code manager 118 and the association is formed by the class code manager 118.

At 610, a transaction record (e.g., transaction record 122) of the transaction is recorded, including the associated transaction class code and transaction data of the transaction.

Further, in some examples, a request for a transaction statement is received. The request includes a request for data associated with the transaction of the recorded transaction record and a plurality of other transactions for which transaction records have been recorded with associated transaction class codes. In some such examples, the plurality of other transactions are transactions that occurred within a defined date/time range. Additionally, or alternatively, the plurality of other transactions that are associated with a defined subset of transaction class codes. In other examples, the set of transactions requested for the transaction statement are related in another way without departing from the description.

The transaction statement is generated, and it includes transaction data associated with the transaction and the plurality of other transactions, wherein the transaction data is organized according to transaction class codes with which the transaction and plurality of other transactions are associated (e.g., the statement displays transaction data of transactions in groups that share transaction class codes). The generated transaction statement is then provided in response to the received request.

Additionally, or alternatively, in some examples, the transaction class codes are associated with class descriptions via a defined class code map. In such examples, generated transaction statements include the class descriptions associated with the transaction class codes as described herein. In an example, a set of transactions associated with a transaction class code and class description of “groceries” is displayed in the transaction statement as being associated with a category of “groceries”. In other examples, the associated class descriptions are used in other ways with respect to the transaction class codes without departing from the description.

Additionally, or alternatively, in some examples, the plurality of transaction class codes of the account includes a hierarchical structure of class codes and related sub-class codes (e.g., class codes that indicate departments generally and sub-class codes that indicate specific transaction types within those departments). In such examples, transaction class codes received and/or otherwise associated with transactions can include a class code and an associated sub-class code. In other examples, more hierarchical levels of codes are used (e.g., a transaction associated with a class code, a first sub-class code of the class code, and a second sub-class code of the first sub-class code) without departing from the description. Additionally, or alternatively, in some examples, multiple transaction class codes are associated with a transaction, such that the transaction is part of multiple classifications or categories, without departing from the description.

### Exemplary Operating Environment

The present disclosure is operable with a computing apparatus according to an embodiment as a functional block diagram 700 in FIG. 7. In an example, components of a computing apparatus 718 are implemented as a part of an electronic device according to one or more embodiments described in this specification. The computing apparatus 718 comprises one or more processors 719 which may be microprocessors, controllers, or any other suitable type of processors for processing computer executable instructions to control the operation of the electronic device. Alternatively, or in addition, the processor 719 is any technology capable of executing logic or instructions, such as a hard-coded machine. In some examples, platform software comprising an operating system 720 or any other suitable platform software is provided on the apparatus 718 to enable application software 721 to be executed on the device. In some examples, collecting transaction class codes in association with transaction at a POS as described herein is accomplished by software, hardware, and/or firmware.

In some examples, computer executable instructions are provided using any computer-readable media that are accessible by the computing apparatus 718. Computer-readable media include, for example, computer storage media such as a memory 722 and communications media. Computer storage media, such as a memory 722, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media do not include communication media. Therefore, a computer storage medium should not be interpreted to be a propagating signal per se. Propagated signals per se are not examples of computer storage media. Although the computer storage medium (the memory 722) is shown within the computing apparatus 718, it will be appreciated by a person skilled in the art, that, in some examples, the storage is distributed or located remotely and accessed via a network or other communication link (e.g., using a communication interface 723).

Further, in some examples, the computing apparatus 718 comprises an input/output controller 724 configured to output information to one or more output devices 725, for example a display or a speaker, which are separate from or integral to the electronic device. Additionally, or alternatively, the input/output controller 724 is configured to receive and process an input from one or more input devices 726, for example, a keyboard, a microphone, or a touchpad. In one example, the output device 725 also acts as the input device. An example of such a device is a touch sensitive display. The input/output controller 724 may also output data to devices other than the output device, e.g., a locally connected printing device. In some examples, a user provides input to the input device(s) 726 and/or receive output from the output device(s) 725.

The functionality described herein can be performed, at least in part, by one or more hardware logic components. According to an embodiment, the computing apparatus 718 is configured by the program code when executed by the processor 719 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, etc.) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example system comprises: a processor; and a memory comprising computer program code, the memory and the computer program code configured to, with the processor, cause the processor to: receive a notification that a transaction associated with an account has been initiated; send a prompt for collection of a transaction class code of the transaction from a plurality of transaction class codes of the account; receive a transaction class code in response to the prompt; associate the received transaction class code with the transaction; and record a transaction record of the transaction including the associated transaction class code and transaction data of the transaction.

An example computerized method comprises: receiving a notification that a transaction associated with an account has been initiated; sending a prompt for collection of a transaction class code of the transaction from a plurality of transaction class codes of the account; receiving a transaction class code in response to the prompt; associating the received transaction class code with the transaction; and recording a transaction record of the transaction including the associated transaction class code and transaction data of the transaction.

One or more computer storage media having computer-executable instructions that, upon execution by a processor, cause the processor to at least: receive a notification that a transaction associated with an account has been initiated; send a prompt for collection of a transaction class code of the transaction from a plurality of transaction class codes of the account; receive a transaction class code in response to the prompt; associate the received transaction class code with the transaction; and record a transaction record of the transaction including the associated transaction class code and transaction data of the transaction.

Alternatively, or in addition to the other examples described herein, examples include any combination of the following:
receiving a request for a transaction statement including the transaction and a plurality of other transactions for which transaction records have been recorded with associated transaction class codes; generating a transaction statement including transaction data associated with the transaction and the plurality of other transactions, wherein the transaction data is organized according to transaction class codes with which the transaction and plurality of other transactions are associated; and providing the generated transaction statement in response to the received request.
wherein the transaction data of the generated transaction statement includes class descriptions for each of the transaction and the plurality of other transactions, wherein the class descriptions are associated with transaction class codes based on a defined class code map.
wherein sending a prompt for collection of a transaction class code of the transaction from a plurality of transaction class codes of the account includes: generating a suggested transaction class code for the transaction from the plurality of transaction class codes of the account; and providing the generated suggested transaction class code with the prompt for collection of the transaction class code of the transaction, whereby a user is enabled to select the suggested transaction class code as the transaction class code for the transaction.
wherein generating the suggested transaction class code includes: providing transaction data of the transaction to a classification model as input; and generating the suggested transaction class code as output of the classification model.
further comprising: obtaining transaction data and transaction class codes from the recorded transaction record and a plurality of other transaction records; providing the obtained transaction data to the classification model as input; generating a set of suggested transaction class codes as output of the classification model; comparing the generated set of suggested transaction class codes to the obtained transaction class codes of the recorded transaction record and the plurality of other transaction records; and adjusting the classification model based on comparing of the generated set of suggested transaction class codes to the obtained transaction class codes using a machine learning technique, whereby accuracy of the classification model in generating suggested transaction class codes is improved relative to the recorded transaction record and the plurality of other transaction records.
wherein the plurality of transaction class codes of the account includes a hierarchical structure of class codes and related sub-class codes; and wherein receiving the transaction class code in response to the prompt includes receiving a class code and a related sub-class code indicating a more specific classification than the received transaction class code alone.

Any range or device value given herein may be extended or altered without losing the effect sought, as will be apparent to the skilled person.

Examples have been described with reference to data monitored and/or collected from the users (e.g., user identity data with respect to profiles). In some examples, notice is provided to the users of the collection of the data (e.g., via a dialog box or preference setting) and users are given the opportunity to give or deny consent for the monitoring and/or collection. The consent takes the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute an exemplary means for receiving a notification that a transaction associated with an account has been initiated; exemplary means for sending a prompt for collection of a transaction class code of the transaction from a plurality of transaction class codes of the account; exemplary means for receiving a transaction class code in response to the prompt; exemplary means for associating the received transaction class code with the transaction; and exemplary means for recording a transaction record of the transaction including the associated transaction class code and transaction data of the transaction.

The term “comprising” is used in this specification to mean including the feature(s) or act(s) followed thereafter, without excluding the presence of one or more additional features or acts.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
a processor; and
a memory comprising computer program code, the memory and the computer program code configured to, with the processor, cause the processor to:
receive a notification that a transaction associated with an account has been initiated;
send a prompt for collection, from a user, of a transaction class code for the transaction from a plurality of transaction class codes of the account;
receive a transaction class code in response to the prompt;
associate the received transaction class code with the transaction; and
upon completion of the transaction, record a transaction record of the transaction including the associated transaction class code and transaction data of the transaction.

2. The system of claim 1, wherein the memory and the computer program code are configured to, with the processor, further cause the processor to:
receive a request for a transaction statement including the transaction and a plurality of other transactions for which transaction records have been recorded with associated transaction class codes;
generate a transaction statement including transaction data associated with the transaction and the plurality of other transactions, wherein the transaction data is organized according to transaction class codes with which the transaction and plurality of other transactions are associated; and
provide the generated transaction statement in response to the received request.

3. The system of claim 2, wherein the transaction data of the generated transaction statement includes class descriptions for each of the transaction and the plurality of other transactions, wherein the class descriptions are associated with transaction class codes based on a defined class code map.

4. The system of claim 1, wherein sending a prompt for collection of a transaction class code of the transaction from a plurality of transaction class codes of the account includes:
generating a suggested transaction class code for the transaction from the plurality of transaction class codes of the account; and
providing the generated suggested transaction class code with the prompt for collection of the transaction class code of the transaction, whereby the user is enabled to select, at a point of sale, the suggested transaction class code as the transaction class code for the transaction.

5. The system of claim 4, wherein generating the suggested transaction class code includes:
providing transaction data of the transaction to a classification model as input; and
generating the suggested transaction class code as output of the classification model.

6. The system of claim 5, wherein the memory and the computer program code are configured to, with the processor, further cause the processor to:
obtain transaction data and transaction class codes from the recorded transaction record and a plurality of other transaction records;
provide the obtained transaction data to the classification model as input;
generate a set of suggested transaction class codes as output of the classification model;
compare the generated set of suggested transaction class codes to the obtained transaction class codes of the recorded transaction record and the plurality of other transaction records; and
adjust, using machine learning, the classification model based on the comparing of the generated set of suggested transaction class codes to the obtained transaction class codes, whereby accuracy of the classification model in generating suggested transaction class codes is improved relative to the recorded transaction record and the plurality of other transaction records.

7. The system of claim 1, wherein the plurality of transaction class codes of the account includes a hierarchical structure of class codes and related sub-class codes; and
wherein receiving the transaction class code in response to the prompt includes receiving a class code and a related sub-class code indicating a more specific classification than the received transaction class code alone.

8. A computerized method comprising:
receiving a notification that a transaction associated with an account has been initiated;
sending a prompt for collection, from a user, of a transaction class code of the transaction from a plurality of transaction class codes of the account;
receiving a transaction class code in response to the prompt;
associating the received transaction class code with the transaction; and
upon completion of the transaction, recording a transaction record of the transaction including the associated transaction class code and transaction data of the transaction.

9. The computerized method of claim 8, further comprising:
receiving a request for a transaction statement including the transaction and a plurality of other transactions for which transaction records have been recorded with associated transaction class codes;
generating a transaction statement including transaction data associated with the transaction and the plurality of other transactions, wherein the transaction data is organized according to transaction class codes with which the transaction and plurality of other transactions are associated; and
providing the generated transaction statement in response to the received request.

10. The computerized method of claim 9, wherein the transaction data of the generated transaction statement includes class descriptions for each of the transaction and the plurality of other transactions, wherein the class descriptions are associated with transaction class codes based on a defined class code map.

11. The computerized method of claim 8, wherein sending a prompt for collection of a transaction class code of the transaction from a plurality of transaction class codes of the account includes:
generating a suggested transaction class code for the transaction from the plurality of transaction class codes of the account; and
providing the generated suggested transaction class code with the prompt for collection of the transaction class code of the transaction, whereby the user is enabled to select, at a point of sale, the suggested transaction class code as the transaction class code for the transaction.

12. The computerized method of claim 11, wherein generating the suggested transaction class code includes:
providing transaction data of the transaction to a classification model as input; and
generating the suggested transaction class code as output of the classification model.

13. The computerized method of claim 12, further comprising:
obtaining transaction data and transaction class codes from the recorded transaction record and a plurality of other transaction records;
providing the obtained transaction data to the classification model as input;
generating a set of suggested transaction class codes as output of the classification model;
comparing the generated set of suggested transaction class codes to the obtained transaction class codes of the recorded transaction record and the plurality of other transaction records; and
adjusting, using machine learning, the classification model based on the comparing of the generated set of suggested transaction class codes to the obtained transaction class codes, whereby accuracy of the classification model in generating suggested transaction class codes is improved relative to the recorded transaction record and the plurality of other transaction records.

14. The computerized method of claim 8, wherein the plurality of transaction class codes of the account includes a hierarchical structure of class codes and related sub-class codes; and
wherein receiving the transaction class code in response to the prompt includes receiving a class code and a related sub-class code indicating a more specific classification than the received transaction class code alone.

15. One or more computer storage media having computer-executable instructions that, upon execution by a processor, cause the processor to at least:
receive a notification that a transaction associated with an account has been initiated;
send a prompt for collection, from a user, of a transaction class code of the transaction from a plurality of transaction class codes of the account;
receive a transaction class code in response to the prompt;
associate the received transaction class code with the transaction; and
upon completion of the transaction, record a transaction record of the transaction including the associated transaction class code and transaction data of the transaction.

16. The one or more computer storage media of claim 15, wherein the computer-executable instructions, upon execution by the processor, further cause the processor to at least:
receive a request for a transaction statement including the transaction and a plurality of other transactions for which transaction records have been recorded with associated transaction class codes;
generate a transaction statement including transaction data associated with the transaction and the plurality of other transactions, wherein the transaction data is organized according to transaction class codes with which the transaction and plurality of other transactions are associated; and
provide the generated transaction statement in response to the received request.

17. The one or more computer storage media of claim 16, wherein the transaction data of the generated transaction statement includes class descriptions for each of the transaction and the plurality of other transactions, wherein the class descriptions are associated with transaction class codes based on a defined class code map.

18. The one or more computer storage media of claim 15, wherein sending a prompt for collection of a transaction class code of the transaction from a plurality of transaction class codes of the account includes:
generating a suggested transaction class code for the transaction from the plurality of transaction class codes of the account; and
providing the generated suggested transaction class code with the prompt for collection of the transaction class code of the transaction, whereby a user is enabled to select, at a point of sale, the suggested transaction class code as the transaction class code for the transaction.

19. The one or more computer storage media of claim 18, wherein generating the suggested transaction class code includes:
providing transaction data of the transaction to a classification model as input; and
generating the suggested transaction class code as output of the classification model.

20. The one or more computer storage media of claim 19, wherein the computer-executable instructions, upon execution by the processor, further cause the processor to at least:
obtain transaction data and transaction class codes from the recorded transaction record and a plurality of other transaction records;
provide the obtained transaction data to the classification model as input;
generate a set of suggested transaction class codes as output of the classification model;
compare the generated set of suggested transaction class codes to the obtained transaction class codes of the recorded transaction record and the plurality of other transaction records; and
adjust, using machine learning, the classification model based on the comparing of the generated set of suggested transaction class codes to the obtained transaction class codes, whereby accuracy of the classification model in generating suggested transaction class codes is improved relative to the recorded transaction record and the plurality of other transaction records.
